(19) United States
(12) Patent Application Publication
(10) Pub. No.: US 2026/0117762 A1
(43) Pub. Date: Apr. 30, 2026

(54) AIR FLOW VERIFICATION STATION

(71) Applicant: L'OREAL, Paris (FR)

(72) Inventor: Rafael FELICIANO, New Providence, NJ (US)

(73) Assignee: L'OREAL, Paris (FR)

(21) Appl. No.: 18/929,799

(22) Filed: Oct. 29, 2024

(51) Int. Cl. F04B 51/00; F04B 43/12; G01M 99/00

(52) U.S. Cl. CPC F04B 51/00; F04B 43/12; G01M 99/005

(57) ABSTRACT

A flow verification system and a method for verifying flow in a peristaltic pump system. A flow verification system includes a gas source configured for fluidic communication with a peristaltic pump system, and a flow verification module for fluidic communication with a peristaltic pump system. Passage of gas into the flow verification module causes a response, which corresponds to an ability of the peristaltic pump system to pump the non-gaseous fluid therethrough. A method for verifying flow includes connecting a peristaltic pump system to a gas source, connecting the peristaltic pump system to a flow verification module, flowing gas from the gas source into the peristaltic pump system, operating the peristaltic pump system, and flowing the gas from the plurality of outlet nozzles into the flow verification module, thereby causing the response, which corresponds to an ability of the peristaltic pump system to pump the non-gaseous fluid therethrough.

### SUMMARY

Aspects of the present disclosure relate to flow verification systems and methods for verification of flow of a non-gaseous fluid through a peristaltic pump system.

In an aspect, the disclosure provides a flow verification system for verification of flow of a non-gaseous fluid through a peristaltic pump system, the flow verification system including: a gas source configured for fluidic connection to a peristaltic pump inlet of the peristaltic pump system for passage of a gas of the gas source therethrough; and a flow verification module configured for a fluidic connection to a peristaltic pump outlet of the peristaltic pump system, wherein the flow verification module is configured to provide a response to a flow of the gas therein; wherein passage of the gas through the peristaltic pump system and into the flow verification module causes the response, which corresponds to an ability of the peristaltic pump system to pump the non-gaseous fluid therethrough.

In embodiments, the gas source is a compressed air gas source configured to connect to and provide a consistent flow rate of air into the peristaltic pump system for a consistent flow rate of air from the plurality of outlet nozzles of the peristaltic pump system. The plurality of outlet nozzles fluidically connect to a plurality of flow channels comprising a plurality of flow path distances.

In embodiments, the plurality of flow path distances of the plurality of flow channels differ in magnitude of distances, and wherein a flow rate of the gas is configured to facilitate a consistent flow rate of the gas out of the plurality of outlet nozzles and corresponds to a flow rate of the non-gaseous fluid for a consistent expulsion of the non-gaseous fluid therefrom.

In embodiments, the flow verification module comprises a plurality of water vessels, wherein the response comprises formation of bubbles in each water vessel of the plurality of water vessels. a water level in the plurality of water vessels is configured to prevent water from back flowing into the plurality of outlet nozzles in the absence of the flow of the gas.

In embodiments, the flow verification module comprises a plurality of flow sensors, wherein the response comprises registration of the flow of the gas by each flow sensor of the plurality of flow sensors which corresponds to the ability of the peristaltic pump system to pump the non-gaseous fluid therethrough.

In an aspect, the disclosure provides a method for verifying flow of a non-gaseous fluid in a peristaltic pump system, the method comprising: connecting a peristaltic pump inlet of the peristaltic pump system to a gas source; connecting a peristaltic pump outlet of the peristaltic pump system to a plurality of flow verification modules, wherein the flow verification modules are configured to provide a response to a flow of the gas therein; flowing gas from the gas source into the peristaltic pump inlet; operating a peristaltic pump of the peristaltic pump system, thereby enabling the flow of the gas through an internal flow channel, out the peristaltic pump outlet, to and through a plurality of outlet nozzles of the peristaltic pump system into the flow verification modules, thereby causing the response, which corresponds to an ability of the peristaltic pump system to pump the non-gaseous fluid therethrough.

In embodiments, the gas source is a compressed air gas source configured to provide a consistent flow rate of air from the plurality of outlet nozzles of the peristaltic pump system.

In embodiments, the plurality of flow verification modules comprises a plurality of water vessels, and wherein the response comprises formation of gas bubbles comprised of the gas of the gas source in each water vessel of the plurality of water vessels which corresponds to the ability of the peristaltic pump system to pump the non-gaseous fluid therethrough. In embodiments, the plurality of flow verification modules comprises a plurality of flow sensors, and wherein the response comprises registration of the flow of the gas by each flow sensors of the plurality of flow sensors which corresponds to the ability of the peristaltic pump system to pump the non-gaseous fluid therethrough. In embodiments, the plurality of flow verification modules further comprises a plurality of flow verification modules comprising a plurality of water vessels and a plurality of flow sensors.

In embodiments the flow is a gas flow rate value indicative of a level or rate of flow. In embodiments, the method further comprises comparing the gas flow rate value to a reference for a comparison and verifying the level or rate of flow based on the comparison. In embodiments, the plurality of outlet nozzles fluidically connect to a plurality of flow channels comprising a plurality of flow path distances, wherein the plurality of flow path distances of the plurality of flow channels differ in magnitude of distances, and wherein a flow rate of the gas is configured to facilitate a consistent flow rate of the gas out of the plurality of outlet nozzles and corresponds to a flow rate of the non-gaseous fluid for a consistent expulsion of the non-gaseous fluid therefrom.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

FIG. 1 is a schematic of a flow verification system with a plurality of water vessels as the flow verification module, according to aspects of the present disclosure;

FIG. 2 is a schematic of a flow verification system with a plurality of flow sensors as the flow verification module, according to aspects of the present disclosure;

FIG. 3 is a first perspective view of one representative embodiment of a formulation delivery appliance, according to aspects of the present disclosure;

FIG. 4 is a partial cutaway window perspective view of the formulation delivery appliance of FIG. 3, showing components within a consumable assembly and a handle assembly, according to aspects of the present disclosure;

FIG. 5 is a perspective view of a portion of the consumable assembly of the formulation delivery appliance of FIG. 3, showing the consumable assembly in a sealed configuration, according to aspects of the present disclosure;

FIG. 6 is a perspective view of a formulation dispensing assembly, according to aspects of the present disclosure;

FIG. 7 is a side section view of the formulation dispensing assembly of FIG. 6, according to aspects of the present disclosure; and

FIG. 8 is a block diagram of a method for verifying flow in a peristaltic pump system, according to aspects of the present disclosure.

TABLE 1
Listing of Drawing Elements

| | |
|---|---|
| 100 flow verification system | 600 peristaltic pump system |
| 102 peristaltic pump inlet | 602 first formulation tube |
| 106 peristaltic pump outlet | 603 second formulation tube |
| 115 outlet nozzle | 630 outlet nozzle |
| 120 gas source | 650 peristaltic pump system |
| 122 gas source outlet | 652 peristaltic pump |
| 124 gas line | 602a first formulation inlet |
| 130 flow channel | 603b second formulation inlet |
| 132 flow channel inlet | 654 motor |
| 134 flow channel outlet | 656 gearbox |
| 140 flow verification module | 800 routine |
| 145 water level | 802 connect a peristaltic pump |
| 148 bubble | inlet to a gas source |
| 150 peristaltic pump system | 804 connect a peristaltic pump |
| 240 flow verification module | outlet to a flow verification |
| 242 flow sensors | module |
| 300 formula delivery device | 806 flow gas from the gas |
| 306 control button | source into the peristaltic |
| 310 handle shell | pump inlet |
| 315 parting surface | 808 operate the peristaltic |
| 316 release button | pump system |
| 320 consumable assembly | 810 flow the gas from the |
| 322 head cover | plurality of outlet nozzles into |
| 340 standoff protrusion | the flow verification module, |
| 352 peristaltic pump | thereby causing a response |
| 330 outlet nozzle | 812 flow verified by bubbling |
| 302 first formulation tube | in water vessels |
| 303 second formulation tube | |
| 350 peristaltic pump system | 814 flow verified by |
| 354 piercing portion | registering flow on flow |
| 355 piercing tip | sensor |

The foregoing aspects and many of the attendant advantages of this disclosure will become more readily appreciated as the same become better understood by reference to the following detailed description, when taken in conjunction with the accompanying drawings.

### DETAILED DESCRIPTION

The detailed description set forth below in connection with the appended drawings, where like numerals reference like elements, is intended as a description of various embodiments of the disclosed subject matter and is not intended to represent the only embodiments. Embodiments described in this disclosure are provided merely as examples or illustrations and should not necessarily be construed as preferred or advantageous over other embodiments. The illustrative examples provided herein are not intended to be exhaustive or to limit the claimed subject matter to the precise forms disclosed.

The present disclosure relates generally to a flow verification system for a peristaltic pump system and an improved method for verifying flow through the peristaltic pump system. Peristaltic pumps can be used for moving non-gaseous fluids through a fluid system. Examples of non-gaseous fluids include liquids, solutions, colloids, suspensions, mixtures, and the like. Peristaltic pumps typically contain a circular casing, a number of rollers attached to the external circumference of a motor, and a flexible tube set in between that carries a non-gaseous fluid. As rollers apply pressure to the flexible tube, the non-gaseous fluid is pushed through the tube. An advantage of this type of system is that the non-gaseous fluid in the tube does not contact any of the motor components, therefore making peristaltic pumps useful for pumping fluids that are messy, chemically hazardous, or sensitive to contamination.

Because of these features of peristaltic pumps, these types of systems are commonly used across a wide number of industries, including in medicine (such as in dialysis or medical infusion), agriculture, food manufacturing, chemical handling and manufacturing, engineering, aquariums, and wastewater and sewage treatment, as well as any other industries where maintaining a separation between the pump mechanics and a non-gaseous fluid are advantageous.

Despite these advantages, one problem of peristaltic pump systems is that they typically require calibration, quality control, and quality assurance to establish and maintain consistent provision of a desired flow rate. This can involve running a calibration non-gaseous fluid through the peristaltic pump system in order to verify which motor speed corresponds to a particular non-gaseous fluid flow rate. However, with many calibration non-gaseous fluids, it can be difficult to clean the inside of the tubing, particularly in instances in which a long reel of tubing is used. Non-gaseous fluids and liquids left inside the tubing can lead to microbial growth, as well as contamination of samples when tested in the future. Shorter segments of tubing with connecting junctions can be used to attempt to mitigate this problem by allowing a user to take apart and clean the system, but that often requires taking apart additional components of a broader system that houses the peristaltic pump. Drying procedures can also be implemented, but these can be time consuming and lead to extensive downtime of a device that includes a peristaltic pump system. In a production environment, these disadvantages can be costly.

Accordingly, there is a need for improved systems and methods that enable clean, efficient, accurate, and precise testing of peristaltic pump systems for quality tests and/or calibrations in a cost-effective manner. The present disclosure addresses these and other long-felt and unmet needs in the art.

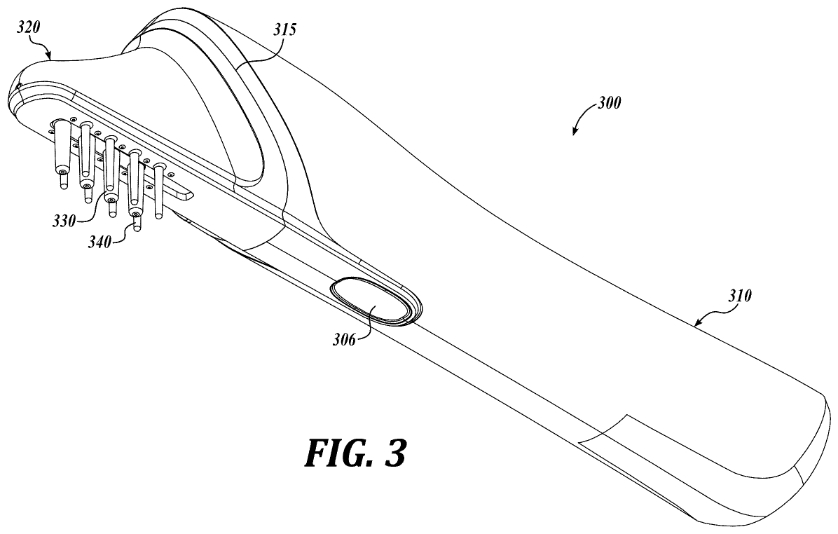

In an aspect, the present disclosure provides a flow verification system for verification of flow of a non-gaseous fluid through a peristaltic pump system, such as one contained in a formula delivery device 300 (described further herein with respect to FIGS. 3-7). However, it is to be understood that the flow verification system of the present disclosure can be used for verifying flow in any peristaltic pump system, such as in a system useful in the industries identified above.

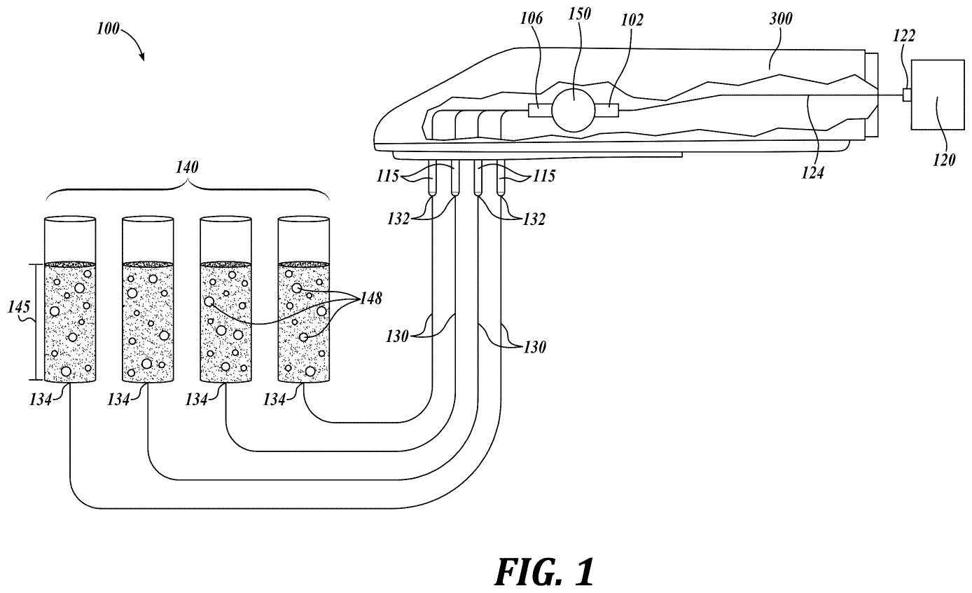

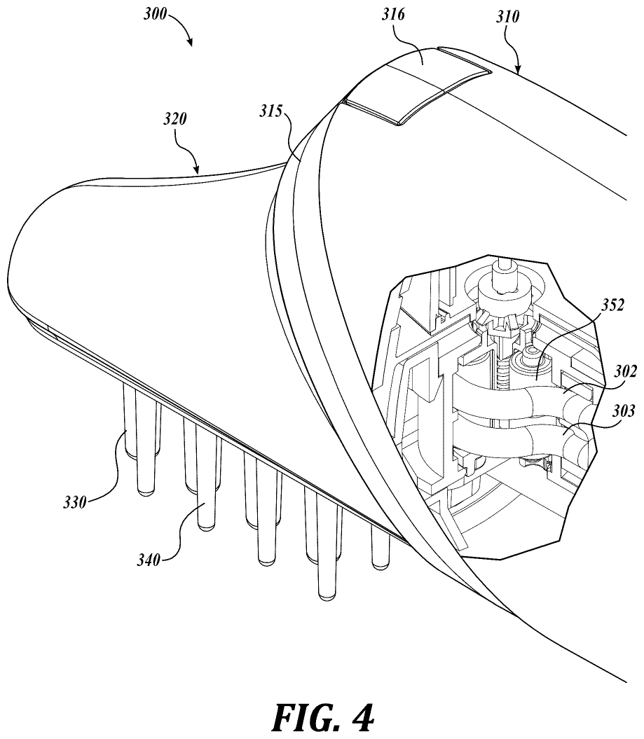

Referring initially to FIG. 1, an embodiment of a flow verification system 100 is depicted. FIG. 1 is a schematic side view illustration of flow verification system 100. Flow verification system 100 is shown to comprise a gas source 120, a plurality of flow channels 130, and a flow verification module 140. Additional structures, such as those illustrated in FIGS. 4-7, are not shown in FIG. 1 to simplify illustration of the overall schematic of flow verification system 100.

In an embodiment, gas source 120 comprises a gas source outlet 122 and a gas line 124. The gas source 120 can be a compressed gas tank, a gas compressor system, or any other suitable means of providing a source of pressurized gas. In an embodiment, gas source 120 further comprises a gas control mechanism, whereby a flow rate of gas from the gas source 120 can be modulated. Gas flows out through gas source outlet 122 and into gas line 124. Gas line 124 is fluidly connected to a peristaltic pump inlet 102 of a peristaltic pump system 150. In an embodiment, the gas source 120 is configured to provide a steady flow of input air to the peristaltic pump inlet 102, thereby allowing a consistent rate of output air from the peristaltic pump system 150. When the output air from the peristaltic pump system 150 is flowing at a consistent flow rate, the flow of output air through the plurality of outlet nozzles 115 is also at a consistent flow rate. In an embodiment, the flow rate of gas from the gas source 120 is configured to be at a level to allow peristalsis through each outlet nozzle of the plurality of outlet nozzles 115. By way of non-limiting examples, the flow rate of gas can be controlled with a ball valve, a needle valve, a pressure regulator, and the like.

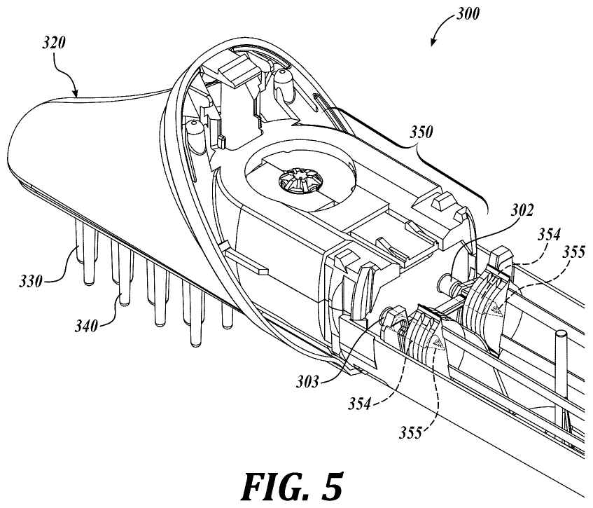

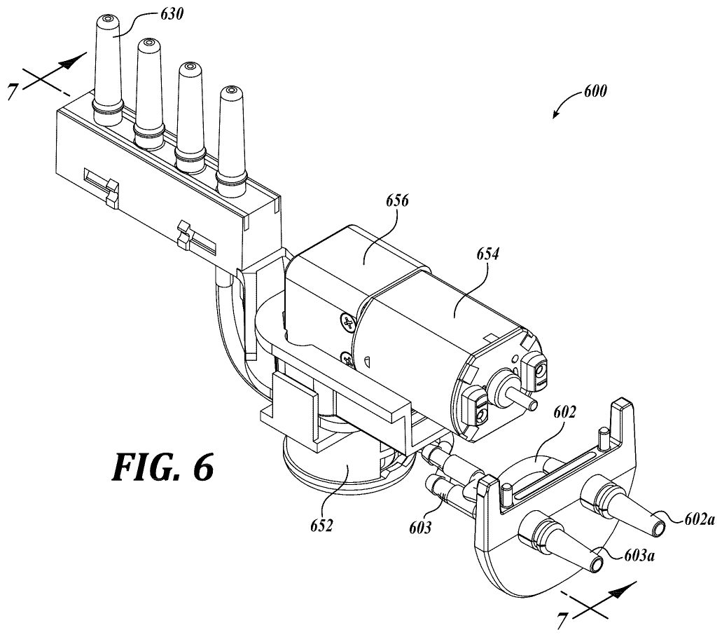

In an embodiment, peristaltic pump system 150 comprises a peristaltic pump (such as peristaltic pump 352 depicted in FIG. 4), a motor (such as motor 654 depicted in FIG. 6), a gearbox (such as gearbox 656 depicted in FIG. 6) a peristaltic pump inlet 102, and a peristaltic pump outlet 106. In an embodiment, the peristaltic pump inlet 102 is a direct connection between gas line 124 and the peristaltic pump system 150. In an embodiment, gas line 124 connects directly to a one or more formulation tubes passing through the peristaltic pump system 150. In an embodiment, the peristaltic pump inlet 102 comprises one or more formulation tubes, (such as first formulation tube 302 and second formulation tube 303 depicted in FIG. 5), a piercing portion (such as piercing portion 354 depicted in FIG. 5), and a piercing tip (such as piercing tip 355 depicted in FIG. 5), as discussed further herein with respect to FIGS. 4-5. The peristaltic pump outlet 106 is fluidly connected to a plurality of outlet nozzles 115.

In an embodiment, the plurality of flow channels 130 comprise a flexible tube. However, it is to be understood that the plurality of flow channels 130 can be made of any suitable material structure, including but not necessarily limited to a plastic tube, a rubberized tube, a silicone tube, a metal tube, such as a steel tube, a glass tube, or the like. Each flow channel 130 of the plurality of flow channels 130 further comprise a flow channel inlet 132 and a flow channel outlet 134.

Each flow channel inlet 132 fluidly connects to each outlet nozzle 115 of the formula delivery device 300. In an embodiment, the flow channel inlet 132 connects directly to each outlet nozzle 115. In an embodiment, each flow channel inlet 132 connects to each outlet nozzle 115 via an intermediary connector, such as a manifold or a valve. The flow channel outlets 134 are configured to fluidly connect to the flow verification module 140. In an embodiment, each flow channel outlet 134 connects directly to the flow verification module 140. In an embodiment, each flow channel outlet 134 connects to each outlet nozzle 115 via an intermediary connector, such as a manifold or a valve.

In the illustrated embodiment, the flow verification module 140 is a plurality of water vessels. In an embodiment, each water vessel of the plurality of water vessels comprises a water level. The water level in each water vessel is configured to prevent water from back flowing into the plurality of outlet nozzles 115. Without being limited by theory, the water level is varied with respect to the vertical position of the plurality of outlet nozzles 115 such that, at equilibrium, water does not flow back through the flow channels 130 and into the peristaltic pump system 150. This can be achieved by placing the water vessels at an elevation lower than the plurality of outlet nozzles 115 and the peristaltic pump system 150.

Each water vessel of the plurality of water vessels is configured to accept a flow of gas from each flow channel 130. When gas flows through each outlet nozzle 115 of the formula delivery device 300 via the peristaltic pump system 150, a plurality of bubbles 148 form in each water vessel of the plurality of water vessels. In embodiments, the rate of bubble formation is a qualitative indicator of flow through the peristaltic pump system 150. In embodiments, the rate of bubble formation is a quantitative indicator of flow through the peristaltic pump system 150. In embodiments, the size of each bubble 148 and the quantity of bubbles 148 are indicative of the flow through the peristaltic pump system 150. In embodiments, the plurality of water vessels are two or more water vessels. An advantage of using two or more water vessels is that each outlet nozzle 115 of the plurality of outlet nozzles 115 can be paired with a water vessel, thereby allowing individualized determination of air flow through the peristaltic pump system 150 and through each outlet nozzle 115.

While the plurality of water vessels is shown and described with respect to water, it is to be understood that the plurality of water vessels can also be a plurality of liquid vessels comprising any suitable liquid, such as an aqueous solution, a saturated aqueous solution, glycerin, a glycerine solution, a corn syrup solution, mineral oil, propylene glycol, ethylene glycol, or any other suitable liquid. In an embodiment, the liquid of the plurality of liquid vessels comprises a viscosity, wherein the viscosity is selected to influence bubble formation, thereby providing additional information about the flow of a gas through the peristaltic pump system 150.

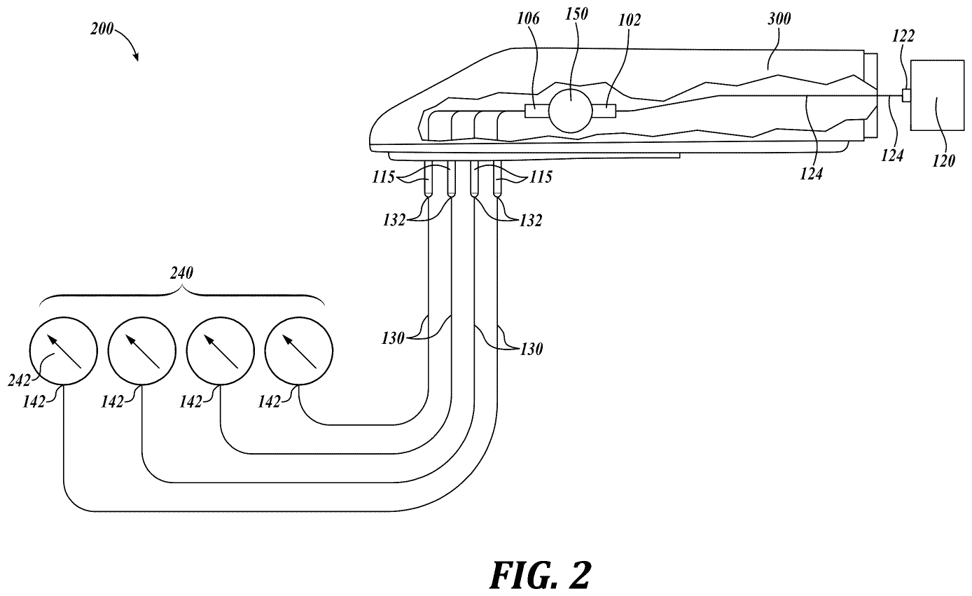

In embodiment, such as that depicted in FIG. 2, the flow verification module 140 is flow verification module 240. Additional structures, such as those illustrated in FIGS. 4-7, are not shown in FIG. 2 to simplify illustration of the overall schematic of flow verification system 100. In that respect, the flow verification module 240 comprise a plurality of flow sensors. Each flow sensor is configured such that, when air flows through each outlet nozzle 115 of the formula delivery device 300, a flow registers on each flow sensor. The flow sensors can be any suitable flow sensor, such as a flow rate sensor, a flow rate gauge, etc. In embodiments, the flow is a non-zero flow rate. In embodiments, each flow sensor is configured to indicate either the absence or the presence of the non-zero flow rate through each flow sensor. In embodiments, the non-zero flow rate is quantitatively determined. In an embodiment, the flow sensors can be any suitable flow sensor for measuring the flow rate of a gas, including but not necessarily limited to ultrasonic meters, electromagnetic meters, paddlewheel meters, floating element meters, thermal meters, differential pressure meters, and the like.

When the non-zero flow rate is determined quantitatively, a discrepancy in flow rate between each outlet nozzle 115 of the plurality of flow rate nozzles can be determined. Such a discrepancy can be used to identify flaws in the internal flow of the formula delivery device 300 and the peristaltic pump system 150 contained therein. In an embodiment, the non-zero flow rate of a gas through the flow sensors is compared with a density of the gas, a density of an intended non-gaseous fluid formulation, and an air pressure correction factor to determine a formulation flow rate through the plurality of outlet nozzles 115. Such a determination is advantageous because it can allow for characterization and calibration of the peristaltic pump system 150 without the introduction of non-gaseous fluids into the internal flow channels, thereby preventing the risk of contamination and microbial growth. Such a determination also can allow for quicker quality control, thereby improving the efficiency of a manufacturing process for devices including a peristaltic pump system, such as formula delivery device 300.

Turning to FIG. 3, an embodiment of a formula delivery device for application of a coloring formulation to a user is depicted (as described in detail in U.S. Pat. No. 11,470,940, which is incorporated by reference herein in its entirety for all purposes). Maintaining a consistent flow rate of formulation through formula delivery device 300 is important for a quality user experience. Therefore, it is advantageous to test each formula delivery device 300 prior to distribution to consumers. A flow verification system, such as the one described with respect to FIGS. 1-2, can be used advantageously to verify that the flow rate of formulation is consistent and even between each of the output nozzles.

The formula delivery device 300 is shown in use with a plurality of outlet nozzles 330 for implementing one or more methodologies or technologies such as, for example, applying a coloring formulation to the hair and/or scalp tissue of a user. For example, some coloring formulations have improved results when applied to a targeted area of the hair of the user, such as when treating the root segments of the hair, as described above. However, conventional hair coloring kits are generally configured for manual mixing and application of the coloring formulation, a method of which is time consuming and not well-suited for consistent, desired results. In addition, results obtained from conventional hair coloring kits are often highly technique-dependent, requiring training and familiarity with the process for the desired results.

By use of the embodiments of the present disclosure, coloring formulation may be applied to portions of the hair in a way that would be difficult to accomplish with direct application of the coloring formulation alone. Embodiments of the present disclosure are also suitable for applying a treatment formulation to any surface of the body of the user or any other suitable surface.

Although the formula delivery device 300 and the other embodiments are described and illustrated as being used with a plurality of outlet nozzles 330, it should be appreciated that the formula delivery devices shown and described herein may be used with any suitable formulation applicator configuration and for any suitable use.

Still referring to FIG. 3, the formula delivery device 300 is shown as an appliance having a handle shell 310, a control button 306, a consumable assembly 320, and a parting surface 315. The handle shell 310 provides a surface for a user to grasp with a hand while using the formula delivery device 300. In this regard, the handle shell 310 is ergonomically shaped in the illustrated embodiments. However, in other embodiments, the handle shell 310 is suitably any shape to contain the internal components and provide one or more gripping surfaces for the user. In further embodiments, the consumable assembly 320 may form at least part of the gripping surfaces for the user.

The handle shell 310 houses various appliance control components, such as one or more of a drive motor having a drive gear, a CPU, a battery, a communications system (such as wireless networking (Wi-Fi), Radio Frequency Identification (RFID), Near Field Communication (NFC), BLUETOOTH®, and the like), an electric and data connector at a port (such as Universal Serial Bus (USB), Firewire, or the like), temperature sensors, accelerometers, fluid sensors, data scanners, light sources, audible signal generator, fluid heating sources, temperature controllers, and other suitable control components, which are not shown in the FIGURES for simplicity. In embodiments, the port is suitably used to provide an interface between the internal control components of the formula delivery device 300 and external components/systems, and/or charge the battery of the formula delivery device 300.

The control button 306 may be configured for the activating, deactivating, and controlling features of the formula delivery device 300. By way of non-limiting examples, control button 306 can be a toggle switch, a pushbutton, a capacitive switch, a potentiometer, or the like. In embodiments, pressing the control button 306 powers on the formula delivery device 300 such that coloring formulation is drawn from a formulation container. In these embodiments, releasing the control button 306 may stop the flow of coloring formulation. In certain examples, the control button 306 may be used to initialize the formula delivery device 300 or place the formula delivery device 300 in a state to perform certain functions, such as one or more of: calculating a mixture ratio of the components of the coloring formulation; entering a cleaning or purging mode; heating the formulation; gathering data from the formulation containers, such as volume remaining, mixture ratios, color information, etc.; sending and receiving signals through the port; analyzing data regarding user preferences; gathering data from sensors; providing status indication to the user, such as power output level, battery life, formulation volume remaining, sensor data, data connection information, etc.; and communicating with auxiliary equipment. In embodiments, the control button 306 is capable of pressure sensitive operation, such that applying a higher pressure to the control button 306 causes a variable response, such as, for example, causing the formulation to flow faster, the nozzles to move faster, or the like. In embodiments, various operating parameters can be controlled by the use of a smart device, such as a phone (as described in detail in U.S. patent application Ser. No. 14/586,138, which is incorporated by reference herein in its entirety for all purposes).

As shown in FIG. 3, the consumable assembly 320 is removably joined with the handle shell 310 to form the formula delivery device 300. The external junction of the consumable assembly 320 and the handle shell 310 is located at the parting surfaces 315 on each assembly. The parting surface 315 are generally configured to mate together forming a minimal gap such that fluid, dirt, debris, and other matter does not ingress the formula delivery device 300. In embodiments, the parting surface 315 mate together in a substantially flush configuration such that no sharp edges exist for ergonomic comfort to the user. Alternatively, in other embodiments, the handle shell 310 may be cut away so the consumable assembly 320 forms at least a portion of the gripping surfaces.

In the illustrated embodiments, to release and remove the consumable assembly 320 from the handle shell 310, a release button 316 (see FIG. 4) may be pressed to release the grip of a consumable assembly detent feature from the release button 316. In other embodiments, other securing configurations are suitably used, such as press-fit, fasteners, hook and loop, releasable adhesive, magnets, and the like. Additional securement features are also within the scope of the present disclosure, such as a lower detent, which may provide a greater securement force between the formula delivery device 300 and the handle shell 310. In other embodiments, any number or combination of securement features are suitably used to secure the consumable assembly 320 to the handle shell 310.

The consumable assembly 320 will now be described in greater detail. The consumable assembly 320 generally includes a head cover 322 to house and enclose various components of the consumable assembly 320, which will be described in greater detail below. The output area of the head cover 322 includes a plurality of outlet nozzles 330 extending from a manifold housing coupled to or formed on the head cover 322. The outlet nozzles 330 are configured to discharge the coloring formulation through a plurality of outlet apertures in the end of the outlet nozzles 330 upon use of the formula delivery device 300. In embodiments, the outlet nozzle 330 are arranged in one or more rows along the length of the head cover 322, generally in a direction along the length of the formula delivery device 300, as shown in the FIGURES. In other embodiments, the outlet nozzles 330 are suitably placed at an angle with respect to the length of the formula delivery device 300.

In embodiments, the outlet nozzles 330 have a length between about 0.5 cm and about 4.0 cm from the manifold housing to the end of the outlet nozzles 330 at the outlet apertures. In other embodiments, the outlet nozzle 330 have a length between about 1.4 cm and about 1.8 cm from the manifold housing to the end of the outlet nozzle 330 at the outlet apertures. In other embodiments, the outlet nozzles 330 have a length of about 1.6 cm from the manifold housing to the end of the outlet nozzles 330 at the outlet apertures. In further embodiments, any length of nozzle is suitably used.

In the illustrated embodiment, a plurality of standoff protrusions 340 extend outwardly substantially in the direction of the outlet nozzles 330 from the head cover 322 in one or more rows. In this regard, substantially in the direction of the outlet nozzles 330 is intended to refer to within and angle of about 25 degrees of the direction along the length of the outlet nozzles 330. In the depicted embodiment, first and second rows of standoff protrusions 340 are positioned along each side of a single row of outlet nozzles 330. In embodiments, the standoff protrusions 340 may be disposed at an angle relative to the plurality of outlet nozzles 330. (For example, see U.S. patent application Ser. No. 15/339,551, which is incorporated by reference herein in its entirety for all purposes.)

In embodiments, each of the standoff protrusions 340 has a length (measuring between the head cover 322 to an end of the standoff protrusions 340) such that the end of the standoff protrusion 340 and the outlet apertures of the outlet nozzles 330 is substantially coplanar. In other embodiments, the standoff protrusions 340 have a length (from the head cover 322 to the end of the standoff protrusion 340) such that the standoff protrusions 340 are longer than a length of the outlet nozzles 330 (measuring between the head cover 322 to an end of the outlet nozzles 330). In this regard, during use, the standoff protrusions 340 would contact an application surface, such as a localized portion of the scalp, and space the outlet aperture of the outlet nozzles 330 away from the application surface to provide a gap for discharge of the coloring formulation through the outlet aperture. In the embodiments where the standoff protrusions 340 are longer than the plurality of outlet nozzles 330, the standoff protrusions 340 are between about 0.1 mm and 5.0 mm longer than the length of each of the plurality of outlet nozzles 330. In other embodiments, the standoff protrusions 340 are between about 0.5 mm and 1.5 mm longer than the length of each of the plurality of outlet nozzles 330. In other embodiments, the standoff protrusions 340 are about 1.0 mm longer than the length of each of the plurality of outlet nozzles 330.

Turning now to the partial cutaway view of the formula delivery device 300 shown in FIG. 4, internal components of the formula delivery device 300 configured for dispensing coloring formulation through the outlet nozzles 330 will now be described (as described in detail in U.S. Pat. No. 11,470,940, which is incorporated by reference herein in its entirety for all purposes). As shown, a first formulation tube 302 and a second formulation tube 303 are configured to transport one of a dye, developer, or other formulation from the fluid container to the manifold housing for mixing and distribution to the outlet nozzles 330. In other embodiments a single formulation tube or more than two formulation tubes are suitably used in the formula delivery device 300. The first formulation tube 302 and second formulation tube 303 are routed past a peristaltic pump 352 consisting of a plurality of rollers to cause the coloring formulation to flow from the fluid container to the manifold housing. In this regard, one advantage of a peristaltic-type pump is that the pump is self-priming.

The peristaltic pump 352 is driven by a suitable a motor 654 (as depicted in FIG. 6) disposed within the handle shell 310. The motor may rotationally drive the drive gear through an elongate drive shaft. The drive gear interfaces with a driven gear configured to drive the various components of the formula delivery device 300, including one or more of the peristaltic pump 352, among other possible components. However, it is to be understood that any suitable motor 654 may be used to drive the peristaltic pump 352.

Turning now to FIG. 5, in embodiments, the consumable assembly 320 is configured for disposal after a specified duration of use, e.g., after a single application of coloring formulation to the user's hair (as described in detail in U.S. Pat. No. 11,470,940, which is incorporated by reference herein in its entirety for all purposes). In these embodiments, the consumable assembly 320 is removed from the handle shell 310 for disposal, and a new consumable assembly 320 is installed into the handle shell 310 for further use.

For retail purposes, packets of the consumable assembly 320 are initially sealed by a sealing member such that coloring dye and/or developer do not leak out of the packet and contaminants do not enter the packets. In embodiments, the sealing member includes an orifice to establish fluid communication between the packet and the first formulation tube 302 and/or second formulation tube 303 when connected. In other embodiments, the sealing member is pierceable, such that the sealing member is punctured when connected to establish fluid communication between the packet and the first formulation tube 302 and/or second formulation tube 303 (as will be described in greater detail below). In the pierceable embodiments, the sealing member is a one or two-way breathable membrane configured to allow outgassing of the packet without the ingress of contaminants or the egress of the contents of the packet. Still, in further embodiments, the scaling member includes a valve, used in conjunction with any of the embodiments herein, the valve configured to regulate the flow of the fluid from the packets. Any combination of the above features may also be used.

In the illustrated embodiment, when the consumable assembly 320 is inserted into the handle shell 310, the consumable assembly 320 transitions from a sealed configuration, where the sealing member is intact, to a fluid flow configuration, where the scaling member has been opened to establish fluid communication between the packet and the first formulation tube 302 and/or second formulation tube 303. In embodiments where the sealing member is pierceable, the ends of the first formulation tube 302 and/or second formulation tube 303 include a piercing portion 354 having a piercing tip 355 to puncture the scaling member upon installation of the consumable assembly 320 within the handle shell 310. The piercing portion 354 defines a fluid receiving chamber therein to receive the fluid and fluidly connect the packet to the first formulation tube 302 and/or second formulation tube 303.

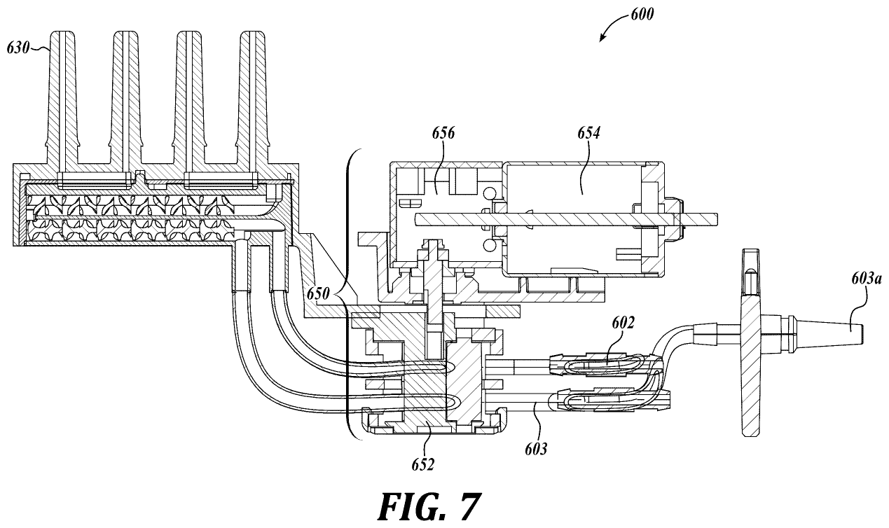

FIGS. 6 and 7 show a representative peristaltic pump system 600, which is compatible with any of the formulation delivery devices, formulation cartridges, and cleaning cartridges described herein (as described in detail in U.S. patent application Ser. No. 18/060,258, which is incorporated by reference herein in its entirety for all purposes). The primary function of the peristaltic pump system 600 is to dispense a mixed formulation of two different formulations from a formulation cartridge onto a user's skin or hair. In embodiments, the peristaltic pump system 600 dispenses the mixed formulation at a flow rate of 20-40 mL/min or 120 mL per four minutes, e.g., 20-35 mL/min, 20-30 mL/min, 20-25 mL/min, 25-35 mL/min, 25-30 mL/min, or 35-40 mL/min.

Peristaltic pump system 600 includes a first formulation inlet 603a and a second formulation inlet 603b, first formulation tube 602 and a second formulation tube 603 fluidically connected to the first formulation inlet 603a and second formulation inlet 603b, respectively. In embodiments, each of the first formulation inlet 603a and second formulation inlet 603b are formed as protrusions extending rearwardly (i.e., toward the cartridge cavity when disposed in the reusable handle) from the first formulation tube 602 and the second formulation tube 603, respectively, toward a rear end of the reusable handle, the protrusions being configured to project into the formulation cartridge.

The formulation dispensing assembly 600 also includes a motor 654, a gearbox 656 operatively connected to the motor 654, and a peristaltic pump 652 driven by the motor 654 via the gearbox 656. The use of a peristaltic pump has been discovered to improve formulation dispensing when utilized in combination with the mixing chambers and tapered formulation channels described herein.

Outlet nozzles 630 are fluidically connected to the first formulation tube 602 and second formulation tube 603 via a turbulent mixing chamber, which mixes a first formulation drawn from the formulation cartridge via the first formulation tube 602 with a second formulation drawing from the formulation cartridge via the second formulation tube 603 to create mixed formulation. In particular, the turbulent mixing chamber mixes the two formulations by combining the same in a common chamber under pressure, and flowing the two formulations past one or more mixing elements, which create turbulent flow of the mixed formulation (as distinguished from laminar flow). The proportions of the first formulation to the second formulation vary in different embodiments. For example, is embodiments, the mixed formulation is a mixture of a first formulation and a second formulation at a ratio of about 0.8:1.0-1.2:1.0, e.g., 0.85, 0.90, 0.95, 1.00, 1.05, 1.10, or 1.15.

In embodiments, the plurality of outlet nozzles 630 have different nozzle outlet diameters. In embodiments, a mixed formulation flow path fluidically connects the nozzle assembly with the mixing chamber, wherein the mixed formulation flow path comprises at least one upstream mixed formulation pool which splits into a plurality of downstream mixed formulation pools. In embodiments, the pump draws the first non-gaseous fluid formulation and the second non-gaseous fluid formulation into the mixing chamber at a first flow rate and a second flow rate, respectively, wherein the first flow rate differs from the second flow rate. In embodiments, the first formulation tube 602 has a first diameter and the second formulation tube 603 has a second diameter, wherein the first diameter differs from the second diameter. In embodiments, the first diameter is less than the second diameter. In embodiments, the first formulation source and the second formulation source are disposed in a formulation cartridge reversibly couplable with the formulation dispensing assembly.

In use, the peristaltic pump 652 draws formulation from the connected formulation cartridge, through the first formulation tube 602 and second formulation tube 603, through the turbulent mixing chamber, through the manifold, and through the outlet nozzles 630. In the illustrated embodiment, the first formulation tube 602 and second formulation tube 603 are kept fluidically separate until downstream of peristaltic pump 652, to prevent mixing of the two formulations until the turbulent mixing chamber. Mixing the two formulations just before dispensation (i.e., between the peristaltic pump 652 and manifold), improves the consistency of the mixed formulation.

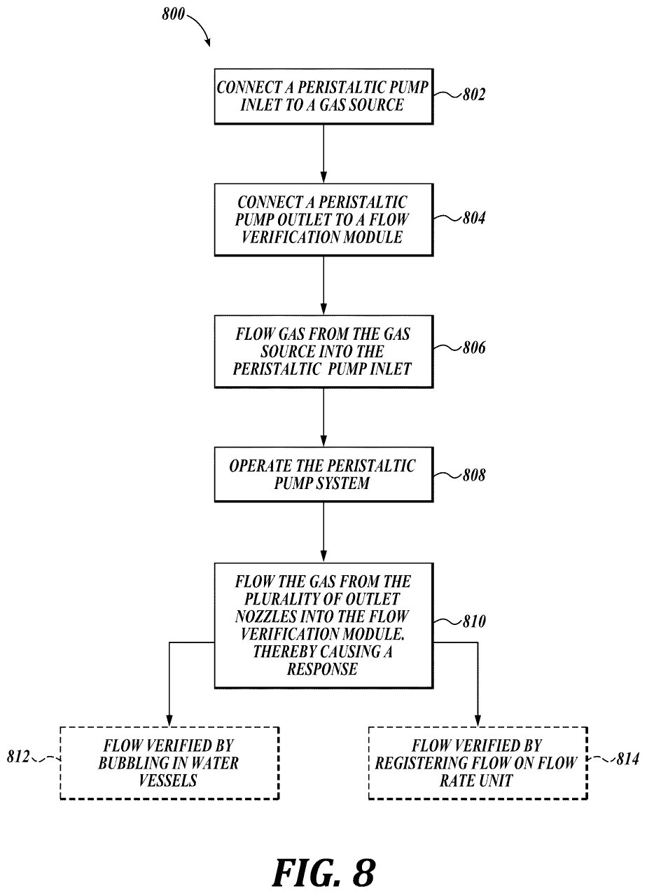

In an aspect, the present disclosure provides a method for verifying flow in a peristaltic pump system. Referring to FIG. 8, routine 800 illustrates a flow verification method in accordance with an embodiment of the present disclosure. In block 802, a peristaltic pump system is connected to a gas source. In block 804, a peristaltic pump system is connected to a plurality of flow verification modules. The flow verification modules are fluidly coupled to the peristaltic pump system via a plurality of outlet nozzles fluidically connect to a plurality of flow channels comprising a plurality of flow path distances. The plurality of flow path distances of the plurality of flow channels differ, and the flow rate of the gas facilitates a consistent flow rate of the gas out of the plurality of outlet nozzles that corresponds to a consistent expulsion of a cosmetic composition therefrom with a use of the peristaltic pump system.

In block 806, pressurized gas is flowed from a gas source and is then flowed into a peristaltic pump inlet of the peristaltic pump system. In an embodiment, the pressurized gas source is configured to provide a steady flow of input air to the inlet of the peristaltic pump system, thereby allowing a consistent rate of output air from the plurality of outlet nozzles of the peristaltic pump system. In an embodiment, the compressed gas source is an air compressor.

In block 808, the peristaltic pump system is operated, thereby allowing the flow of pressurized gas to pass from an outlet of the compressed gas source through an internal flow channel operable with a peristaltic pump to a plurality of outlet nozzles of the peristaltic pump system.

In block 810, the pressurized gas is flowed from the plurality of outlets of the peristaltic pump system into the plurality of flow verification modules. The flow verification modules are configured to provide a response to a flow of the gas therein.

In an embodiment, the plurality of flow verification modules comprise a plurality of water vessels, wherein the response comprises formation of bubbles in each water vessel of the plurality of water vessels. Accordingly, in optional block 812, the flow is verified by observing bubbling in water vessels.

In an embodiment, the plurality of flow verification modules comprise a plurality of flow sensors, wherein the response comprises registration of the flow of the gas by each flow sensor of the plurality of flow sensors. Accordingly, in optional block 814, the flow is verified by registering a flow rate on the flow sensors.

In an embodiment, the plurality of flow verification modules comprise a plurality of flow sensors and a plurality of water vessels, wherein, when gas flows through each outlet nozzle of the plurality of outlet nozzles, bubbles form in each water vessel of the plurality of water vessels, indicative of at least some passage of the gas therefrom for the verifying flow in the peristaltic pump system, and wherein, when gas flows through each outlet nozzle of the plurality of outlet nozzles, a flow registers on each flow sensor of the plurality of flow sensors, indicative of at least some passage of the gas therefrom for the verifying flow in the peristaltic pump system.

In an embodiment, the flow is a gas flow rate value indicative of a level of flow. In an embodiment, the gas flow rate value is compared to a reference flow factor for verifying a liquid flow rate value through the peristaltic pump system. By comparing this reference flow factor to the gas flow rate value, a flow rate of liquid through the peristaltic pump system can be verified without flowing liquid through the peristaltic pump system.

The detailed description set forth above in connection with the appended drawings, where like numerals reference like elements, are intended as a description of various embodiments of the present disclosure and are not intended to represent the only embodiments. Each embodiment described in this disclosure is provided as a representative example or illustration and should not be construed as preferred or advantageous over other embodiments. The representative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification. That is, the present disclosure includes embodiments that combine features from different embodiments.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

In the claims and for purposes of the present disclosure, the terms “a”, “an”, “the”, and the like, refer to the singular and the plural forms of the object or element referenced.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

### NON-LIMITING EMBODIMENTS

While general features of the disclosure are described and shown and particular features of the disclosure are set forth in the claims, the following non-limiting embodiments relate to features, and combinations of features, that are explicitly envisioned as being part of the disclosure. The following non-limiting Embodiments contain elements that are modular and can be combined with each other in any number, order, or combination to form a new non-limiting Embodiment, which can itself be further combined with other non-limiting Embodiments.

Embodiment 1. A flow verification system for verification of flow of a non-gaseous fluid through a peristaltic pump system, the flow verification system comprising: a gas source configured for fluidic connection to a peristaltic pump inlet of the peristaltic pump system for passage of a gas of the gas source therethrough; and a flow verification module configured for a fluidic connection to a peristaltic pump outlet of the peristaltic pump system, wherein the flow verification module is configured to provide a response to a flow of the gas therein; wherein passage of the gas through the peristaltic pump system and into the flow verification module causes the response, which corresponds to an ability of the peristaltic pump system to pump the non-gaseous fluid therethrough.

Embodiment 2. The flow verification system of Embodiment 1 or any other Embodiment, wherein the gas source is a compressed air gas source configured to connect to and provide a consistent flow rate of air into the peristaltic pump system for a consistent flow rate of air from the plurality of outlet nozzles of the peristaltic pump system.

Embodiment 3. The flow verification system of Embodiments 1-2 or any other Embodiment, wherein the plurality of outlet nozzles fluidically connect to a plurality of flow channels comprising a plurality of flow path distances.

Embodiment 4. The flow verification system of Embodiments 1-3 or any other Embodiment, wherein the plurality of flow path distances of the plurality of flow channels differ in magnitude of distances, and wherein a flow rate of the gas is configured to facilitate a consistent flow rate of the gas out of the plurality of outlet nozzles and corresponds to a flow rate of the non-gaseous fluid for a consistent expulsion of the non-gaseous fluid therefrom.

Embodiment 5. The flow verification system of Embodiment 1-4 or any other Embodiment, wherein the flow verification module comprises a plurality of water vessels, wherein the response comprises formation of bubbles in each water vessel of the plurality of water vessels.

Embodiment 6. The flow verification system of Embodiment 1-5 or any other Embodiment, wherein a water level in the plurality of water vessels is configured to prevent water from back flowing into the plurality of outlet nozzles in the absence of the flow of the gas.

Embodiment 7. The flow verification system of Embodiment 1-6 or any other Embodiment, wherein the flow verification module comprises a plurality of flow sensors, wherein the response comprises registration of the flow of the gas by each flow sensor of the plurality of flow sensors which corresponds to the ability of the peristaltic pump system to pump the non-gaseous fluid therethrough.

Embodiment 8. A method for verifying flow of a non-gaseous fluid in a peristaltic pump system, the method comprising: connecting a peristaltic pump inlet of the peristaltic pump system to a gas source; connecting a peristaltic pump outlet of the peristaltic pump system to a plurality of flow verification modules, wherein the flow verification modules are configured to provide a response to a flow of the gas therein; flowing gas from the gas source into the peristaltic pump inlet; operating a peristaltic pump of the peristaltic pump system, thereby enabling the flow of the gas through an internal flow channel, out the peristaltic pump outlet, to and through a plurality of outlet nozzles of the peristaltic pump system into the flow verification modules, thereby causing the response, which corresponds to an ability of the peristaltic pump system to pump the non-gaseous fluid therethrough.

Embodiment 9. The method of Embodiment 8 or any other Embodiment, wherein the gas source is a compressed air gas source configured to provide a consistent flow rate of air from the plurality of outlet nozzles of the peristaltic pump system.

Embodiment 10. The method of Embodiment 8-9 or any other Embodiment, wherein the plurality of flow verification modules comprises a plurality of water vessels, and wherein the response comprises formation of gas bubbles comprised of the gas of the gas source in each water vessel of the plurality of water vessels which corresponds to the ability of the peristaltic pump system to pump the non-gaseous fluid therethrough.

Embodiment 11. The method of Embodiment 8-10 or any other Embodiment, wherein the plurality of flow verification modules comprises a plurality of flow sensors, and wherein the response comprises registration of the flow of the gas by each flow sensors of the plurality of flow sensors which corresponds to the ability of the peristaltic pump system to pump the non-gaseous fluid therethrough.

Embodiment 12. The method of Embodiment 8-11 or any other Embodiment, wherein the plurality of flow verification modules further comprises a plurality of flow sensors, and wherein the response further comprises registration of the flow of the gas by each flow sensors of the plurality of flow sensors which corresponds to the ability of the peristaltic pump system to pump the non-gaseous fluid therethrough.

Embodiment 13. The method of Embodiment 8-12 or any other Embodiment, wherein the flow is a gas flow rate value indicative of a level or rate of flow.

Embodiment 14. The method of Embodiment 8-13 or any other Embodiment, further comprising comparing the gas flow rate value to a reference for a comparison and verifying the level or rate of flow based on the comparison.

Embodiment 15. The method of Embodiment 8-14 or any other Embodiment, wherein the plurality of outlet nozzles fluidically connect to a plurality of flow channels comprising a plurality of flow path distances, wherein the plurality of flow path distances of the plurality of flow channels differ in magnitude of distances, and wherein a flow rate of the gas is configured to facilitate a consistent flow rate of the gas out of the plurality of outlet nozzles and corresponds to a flow rate of the non-gaseous fluid for a consistent expulsion of the non-gaseous fluid therefrom.

While illustrative embodiments have been illustrated and described, it will be appreciated that various changes can be made therein without departing from the spirit and scope of the invention.

The embodiments of the invention in which an exclusive property or privilege is claimed are defined as follows:

1. A flow verification system for verification of flow of a non-gaseous fluid through a peristaltic pump system, the flow verification system comprising:
a gas source configured for fluidic connection to a peristaltic pump inlet of the peristaltic pump system for passage of a gas of the gas source therethrough; and
a flow verification module configured for a fluidic connection to a peristaltic pump outlet of the peristaltic pump system, wherein the flow verification module is configured to provide a response to a flow of the gas therein;
wherein passage of the gas through the peristaltic pump system and into the flow verification module causes the response, which corresponds to an ability of the peristaltic pump system to pump the non-gaseous fluid therethrough.

2. The flow verification system of claim 1, wherein the gas source is a compressed air gas source configured to connect to and provide a consistent flow rate of air into the peristaltic pump system for a consistent flow rate of air from the plurality of outlet nozzles of the peristaltic pump system.

3. The flow verification system of claim 1, wherein the plurality of outlet nozzles fluidically connect to a plurality of flow channels comprising a plurality of flow path distances.

4. The flow verification system of claim 3, wherein the plurality of flow path distances of the plurality of flow channels differ in magnitude of distances, and wherein a flow rate of the gas is configured to facilitate a consistent flow rate of the gas out of the plurality of outlet nozzles and corresponds to a flow rate of the non-gaseous fluid for a consistent expulsion of the non-gaseous fluid therefrom.

5. The flow verification system of claim 1, wherein the flow verification module comprises a plurality of water vessels, and wherein the response comprises formation of gas bubbles comprised of the gas of the gas source in each water vessel of the plurality of water vessels which corresponds to the ability of the peristaltic pump system to pump the non-gaseous fluid therethrough.

6. The flow verification system of claim 5, wherein a water level in the plurality of water vessels is configured to prevent water from back flowing into the plurality of outlet nozzles in the absence of the flow of the gas.

7. The flow verification system of claim 1, wherein the flow verification module comprises a plurality of flow sensors, wherein the response comprises registration of the flow of the gas by each flow sensor of the plurality of flow sensors which corresponds to the ability of the peristaltic pump system to pump the non-gaseous fluid therethrough.

8. A method for verifying flow of a non-gaseous fluid in a peristaltic pump system, the method comprising:
connecting a peristaltic pump inlet of the peristaltic pump system to a gas source;
connecting a peristaltic pump outlet of the peristaltic pump system to a plurality of flow verification modules, wherein the flow verification modules are configured to provide a response to a flow of the gas therein;
flowing gas from the gas source into the peristaltic pump inlet;
operating a peristaltic pump of the peristaltic pump system, thereby enabling the flow of the gas through an internal flow channel, out the peristaltic pump outlet, to and through a plurality of outlet nozzles of the peristaltic pump system into the flow verification modules, thereby causing the response, which corresponds to an ability of the peristaltic pump system to pump the non-gaseous fluid therethrough.

9. The method of claim 8, wherein the gas source is a compressed air gas source configured to provide a consistent flow rate of air from the plurality of outlet nozzles of the peristaltic pump system.

10. The method of claim 8, wherein the plurality of flow verification modules comprises a plurality of water vessels, and wherein the response comprises formation of gas bubbles comprised of the gas of the gas source in each water vessel of the plurality of water vessels which corresponds to the ability of the peristaltic pump system to pump the non-gaseous fluid therethrough.

11. The method of claim 8, wherein the plurality of flow verification modules comprises a plurality of flow sensors, and wherein the response comprises registration of the flow of the gas by each flow sensors of the plurality of flow sensors which corresponds to the ability of the peristaltic pump system to pump the non-gaseous fluid therethrough.

12. The method of claim 10, wherein the plurality of flow verification modules further comprises a plurality of flow sensors, and wherein the response further comprises registration of the flow of the gas by each flow sensors of the plurality of flow sensors which corresponds to the ability of the peristaltic pump system to pump the non-gaseous fluid therethrough.

13. The method of claim 11, wherein the flow is a gas flow rate value indicative of a level or rate of flow.

14. The method of claim 13, further comprising comparing the gas flow rate value to a reference for a comparison and verifying the level or rate of flow based on the comparison.

15. The method of claim 11, wherein the plurality of outlet nozzles fluidically connect to a plurality of flow channels comprising a plurality of flow path distances, wherein the plurality of flow path distances of the plurality of flow channels differ in magnitude of distances, and wherein a flow rate of the gas is configured to facilitate a consistent flow rate of the gas out of the plurality of outlet nozzles and corresponds to a flow rate of the non-gaseous fluid for a consistent expulsion of the non-gaseous fluid therefrom.
